(19) United States
(12) Patent Application Publication
(10) Pub. No.: US 2024/0351872 A1
(43) Pub. Date: Oct. 24, 2024

(54) METHOD AND SYSTEM FOR PRODUCING SYNGAS CONTAINING HYDROGEN FROM WASTE PLASTICS

(71) Applicants: SK INNOVATION CO., LTD., Seoul (KR); SK GEO CENTRIC CO., LTD., Seoul (KR)

(72) Inventors: Yong Woon KIM, Daejeon (KR); Seo Yeong KANG, Daejeon (KR); Soo Kil KANG, Daejeon (KR); Min Gyoo PARK, Daejeon (KR); Young Moo PARK, Daejeon (KR); Min Woo SHIN, Daejeon (KR); Jae Hwan LEE, Daejeon (KR); Jin Seong JANG, Daejeon (KR); Sang Hwan JO, Daejeon (KR)

(21) Appl. No.: 18/639,291

(22) Filed: Apr. 18, 2024

(30) Foreign Application Priority Data
Apr. 19, 2023 (KR) 10-2023-0051637
Nov. 14, 2023 (KR) 10-2023-0157608

(51) Int. Cl. C01B 3/34; C10G 1/10; C10G 67/14

(52) U.S. Cl. CPC C01B 3/34; C10G 1/10; C10G 67/14; C01B 2203/062; C01B 2203/065; C01B 2203/1235; C01B 2203/1258; C10G 2300/1003

(57) ABSTRACT

The embodiments of the present disclosure relate to a method and system for producing syngas containing hydrogen from waste plastics. The method and system for producing syngas containing hydrogen from waste plastics according to the embodiments may minimize formation of an ammonium chloride salt (NH₄Cl) and may prevent an adhesion phenomenon of impurity particles in a reactor in a refining process of waste plastic pyrolysis oil containing impurities including chlorine and nitrogen. In addition, the method and system for producing syngas containing hydrogen from waste plastics according to the embodiments may prevent deactivation of a catalyst used in a process, such that the refining efficiency may be excellent, and the process may be operated for a long period of time.

### CROSS-REFERENCE TO RELATED APPLICATIONS

This application claims priority under 35 U.S.C. § 119 to Korean Patent Application No. 10-2023-0051637, filed on Apr. 19, 2023 and No. 10-2023-0157608, filed on Nov. 14, 2023, the disclosures of which are incorporated herein by reference in their entirety.

### TECHNICAL FIELD

Embodiments of the present disclosure generally relate to a method and system for producing syngas containing hydrogen from waste plastics.

### BACKGROUND

Waste plastics, which are produced by using petroleum as a feedstock, have a low rate of recycling, such as energy recovery in power generation, or mechanical recycling, and a significant amount of waste plastics is simply incinerated or landfilled. These wastes take a long time to degrade in nature, which causes contamination of the soil and serious environmental pollution. As a method for recycling waste plastics, there is a method for pyrolyzing waste plastics and converting the pyrolyzed waste plastics into usable oil, and the oil produced by pyrolyzing waste plastics in this way is called waste plastic pyrolysis oil.

However, since pyrolysis oil obtained by pyrolyzing waste plastics has a higher content of impurities such as chlorine, nitrogen, and metals caused by waste materials than oil produced from crude oil by a general method, there is a risk of emission of air pollutants such as SOx and NOx when the pyrolysis oil is used as fuel, and the pyrolysis oil may be blended in a limited amount with a high-value-added fuel such as gasoline or diesel oil.

As such, as a refining method for removing impurities such as chlorine, nitrogen, oxygen, and metals contained in waste plastic pyrolysis oil, a method of performing dechlorination/denitrification/deoxygenation by reacting waste plastic pyrolysis oil with hydrogen in the presence of a hydrotreating catalyst, a method of removing chlorine contained in waste plastic pyrolysis oil by adsorption using a chlorine adsorbent, or the like is known.

Specifically, U.S. Pat. No. 3,935,295 discloses a technology for removing chloride contaminants from various hydrocarbon oils. The technology is a conventional technology of hydrotreating oil in the presence of a hydrotreating catalyst in a first reactor, introducing a fluid containing hydrogen chloride (HCl) produced at this time and refined oil into a second reactor, and then removing a chlorine component contained in the fluid by adsorption using an adsorbent.

However, as described in the conventional technology, when oil is allowed to react with hydrogen in the presence of a hydrotreating catalyst, a chlorine compound such as hydrogen chloride produced together with refined oil, and a nitrogen compound react with each other to form an ammonium chloride salt (NH₄Cl), and the ammonium chloride salt causes various process complications. Specifically, the ammonium chloride salt formed inside the reactor by the reaction of oil and hydrogen not only causes corrosion of the reactor to reduce durability, but also causes various process issues such as an occurrence of a differential pressure and a resulting reduction in process efficiency. In addition, when the process is operated for a long period of time, adhesion of impurity particles in the waste plastic pyrolysis oil occurs inside the reactor, causing various process complications.

Therefore, there is a need to develop a method capable of producing syngas containing hydrogen from waste plastics while solving the process complications described above.

### SUMMARY

An embodiment of the present disclosure is directed to providing a method and system for producing syngas containing hydrogen from waste plastics that may minimize formation of an ammonium chloride salt (NH₄Cl) in a refining process of waste plastic pyrolysis oil containing impurities including chlorine and nitrogen.

Another embodiment of the present disclosure is directed to providing a method and system for producing syngas containing hydrogen from waste plastics that have excellent refining efficiency and may implement a long-term operation because the activity of a catalyst is maintained for a long time.

Still another embodiment of the present disclosure is directed to providing a method and system for producing syngas containing hydrogen from waste plastics that may prevent an adhesion phenomenon of impurity particles.

Still another embodiment of the present disclosure is directed to providing a method and system for producing syngas containing hydrogen with reduced impurities by significantly reducing a content of impurities such as chlorine, nitrogen, oxygen, and metals and a content of olefins from waste plastics.

According to an embodiment of the present disclosure, a method for producing syngas containing hydrogen from waste plastics includes: S1 introducing waste plastics into a pyrolysis reactor and pyrolyzing the waste plastics to produce pyrolysis gas; S2 producing waste plastic pyrolysis oil by introducing the pyrolysis gas into a hot filter filled with a neutralizing agent; S3 applying a voltage to a first mixed solution obtained by mixing the waste plastic pyrolysis oil, washing water, and a demulsifier to dehydrate the first mixed solution; S4 hydrotreating a second mixed solution obtained by mixing the first mixed solution dehydrated in the operation S3 and a sulfur source to produce refined oil from which impurities are removed; and S5 gasifying the refined oil from which impurities are removed.

In the operation S3, the waste plastic pyrolysis oil may be mixed in a greater volume than the washing water.

In the operation S3, the waste plastic pyrolysis oil and the washing water may be mixed in the first mixed solution at a volume ratio of 1:0.001 to 1:0.5.

In the operation S3, the waste plastic pyrolysis oil and the demulsifier may be mixed in the first mixed solution at a volume ratio of 1:0.000001 to 1:0.001.

The voltage may be applied as an alternating current or a combination of an alternating current and a direct current.

The voltage may be applied through one or more pairs of vertical electrodes.

The method for producing syngas containing hydrogen from waste plastics may further include, after the application of the voltage in the operation S3, removing a rag layer from the first mixed solution.

The operation S3 may be performed under a temperature condition of 20° C. to 300° C.

A ratio of a content of moisture in the waste plastic pyrolysis oil to a content of moisture in the first mixed solution dehydrated in the operation S3 may be 1:0.0001 to 1:0.9.

In the operation S3, the dehydrated first mixed solution may be additionally dehydrated by condensation of moisture.

A weight ratio of nitrogen to chlorine in the second mixed solution may be 1:1 to 1:10.

The sulfur source may include a sulfur-containing oil.

The sulfur-containing oil may be included in an amount of less than 0.5 parts by weight with respect to 100 parts by weight of the first mixed solution dehydrated in the operation S3.

The sulfur source may include one or two or more sulfur-containing organic compounds selected from a disulfide-based compound, a sulfide-based compound, a sulfonate-based compound, and a sulfate-based compound.

The hydrotreating may be performed in the presence of a molybdenum-based hydrotreating catalyst.

The molybdenum-based hydrotreating catalyst may be a catalyst in which a molybdenum-based metal, or a metal including one or two or more selected from nickel, cobalt, and tungsten, and a molybdenum-based metal are supported on a support.

The molybdenum-based hydrotreating catalyst may include a molybdenum-based sulfide hydrotreating catalyst.

The hydrotreating may be performed under a pressure condition of 50 bar to 150 bar.

The method for producing syngas containing hydrogen from waste plastics may further include, after the operation S4, subjecting a stream including the refined oil from which impurities are removed to gas-liquid separation and then washing the gas-liquid separated stream with water.

In the operation S5, a refined fraction separated by distilling the refined oil from which impurities are removed may be gasified.

In the operation S5, mixed oil obtained by mixing the refined oil from which impurities are removed and petroleum hydrocarbons may be gasified.

Other features and aspects will be apparent from the following detailed description, the drawings, and the claims.

### BRIEF DESCRIPTION OF THE DRAWINGS

FIG. 1 is a process diagram of a method for producing syngas containing hydrogen from waste plastics according to an embodiment of the present disclosure.

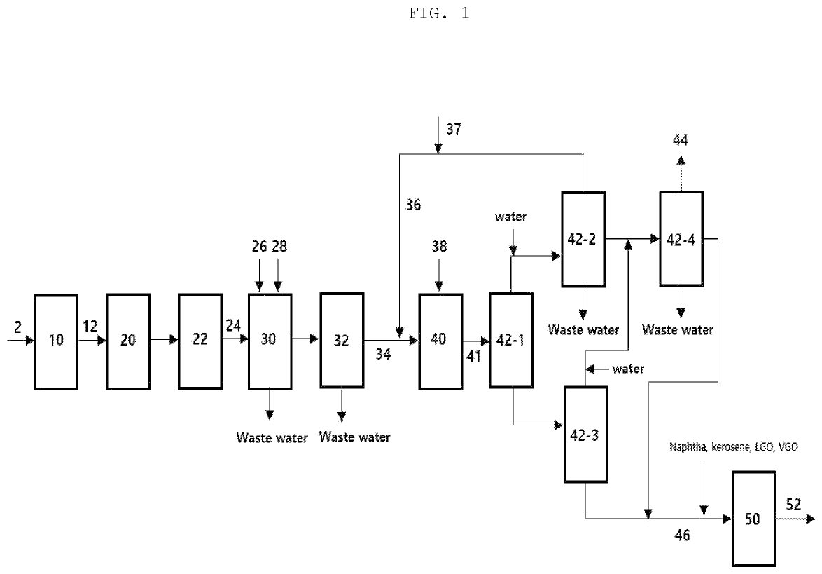

### DETAILED DESCRIPTION OF EMBODIMENTS

The advantages and features of the embodiments of the present disclosure and methods for accomplishing them will become apparent from the embodiments described below in detail. However, the embodiments of the present disclosure are not limited to embodiments to be disclosed below, but may be implemented in various different forms. These embodiments will be provided only in order to make the present disclosure complete and understood by those skilled in the art.

Unless defined otherwise, all terms (including technical and scientific terms) used in the present specification have the same meanings as commonly understood by those skilled in the art to which the present disclosure pertains.

Unless the context clearly indicates otherwise, the singular forms of the terms used in the present specification may be interpreted as including the plural forms.

A numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in this specification, values out of the numerical range that may occur due to experimental errors or rounded values also fall within the defined numerical range.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or processes, all of which are not further recited herein.

The term “reactor” used in the present specification may refer to a device that may be used in processes such as production, refining, separation, and mixing of waste plastic pyrolysis oil. For example, the reactor may be interpreted to mean a device such as a dehydrator, a coalescer, a hydrotreating reactor, or a separator used in a refining process of waste plastic pyrolysis oil.

The term “vertical electrode” used in the present specification may refer to an electrode erected in a vertical direction with respect to the ground, and the term “horizontal electrode” may refer to an electrode laid horizontally with respect to the ground.

In a method and system for producing syngas containing hydrogen from waste plastics according to an embodiment of the present disclosure, an operation of producing pyrolysis gas by pyrolyzing waste plastics, an operation of producing waste plastic pyrolysis oil from the pyrolysis gas, and a dehydration operation including water washing, demulsification, voltage application, and the like are performed, the dehydration operation being performed to reduce complications such as catalyst deactivation due to moisture dispersed in the form of an emulsion in the waste plastic pyrolysis oil, and corrosion of a reactor due to chlorine contained in moisture and a low pH of moisture. In addition, a hydrotreating operation that may minimize formation of an ammonium chloride salt that causes various issues in a process of refining pyrolysis oil, oil refining and petrochemical processes using refined oil as a feedstock, and the like, and a gasification operation of gasifying refined oil from which impurities are removed through the above operations are performed. In the method and system for producing syngas containing hydrogen from waste plastics according to the embodiments of the present disclosure, the above series of temporal operations are organically combined, such that syngas containing hydrogen having a low content of impurities may be stably produced from waste plastic pyrolysis oil.

Hereinafter, the method and system for producing syngas containing hydrogen from waste plastics will be described in detail.

First, operation S1 is a pyrolysis operation of introducing waste plastics 2 into a pyrolysis reactor 10 and pyrolyzing the waste plastics to produce pyrolysis gas 12.

The pyrolysis operation may be performed by heating the waste plastics inside the reactor to a temperature of 400 to 550° C. in a non-oxidizing atmosphere. Specifically, the non-oxidizing atmosphere is an atmosphere in which waste plastics do not oxidize (combust), and may be, for example, an atmosphere in which an oxygen concentration is adjusted to 1 vol % or less, or an atmosphere of an inert gas such as nitrogen, water vapor, carbon dioxide, or argon. When the pyrolysis temperature is 400° C. or higher, fusion of chlorine-containing plastics may be prevented, and when the pyrolysis temperature is 550° C. or lower, chlorine in waste plastics may partially remain in a pyrolysis residue (char).

In the pyrolysis operation, a pyrolysis gas phase, a pyrolysis liquid phase including oil and wax, and a pyrolysis solid phase including a pyrolysis residue may be produced.

The waste plastics may include at least one selected from the group consisting of polyethylene (PE), polypropylene (PP), polyethylene terephthalate (PET), polyvinyl chloride (PVC), and polystyrene (PS). The waste plastics may contain organic chlorine (organic Cl) and inorganic chlorine (inorganic Cl). Waste oil produced through cracking and pyrolysis reactions of waste plastics, such as waste plastic pyrolysis oil, contains a large amount of impurities derived from waste plastics. Accordingly, there is a concern about emission of air pollutants when using waste oil, and in particular, when organic chlorine and inorganic chlorine components are converted into HCl and discharged during a high-temperature treatment process, and thus, it is required to refine the waste oil to remove the impurities such as the chlorine components.

In general, waste plastics may be divided into domestic waste plastic and industrial waste plastic. The domestic waste plastic is a plastic in which PVC, PS, PET, PBT, and the like in addition to PE and PP are mixed, and may refer to a mixed waste plastic containing 3 wt % or more of PVC together with PE and PP in the present disclosure. A content of chlorine in the domestic waste plastic is relatively high, for example, 5,000 ppm or more or 5,000 to 15,000 ppm. PE/PP accounts for most industrial waste plastic, and has a content of chlorine of 100 to 1,000 ppm, 500 to 1,000 ppm, or 700 to 1,000 ppm, which is lower than the content of chlorine in the domestic waste plastic. However, in the industrial waste plastic, a content of organic Cl originating from an adhesive or a dye component is high, and in particular, a proportion of chlorine contained in an aromatic ring is high.

In particular, chlorine originating from PVC in the domestic waste plastic is removed with HCl (hydrogen chloride elimination), whereas chlorine from PE and PP, which account for most industrial waste plastic, originates from an adhesive or a dye component. In most cases, organic chlorine derived from the aromatic ring has a higher proportion than organic chlorine formed at the end of the chain ring and is difficult to remove by general pyrolysis or a neutralizing agent.

The pyrolysis gas produced in the pyrolysis operation may include, with respect to the total weight of the pyrolysis gas, 5 to 35 wt % of Naphtha (bp of 36° C. to 150° C.), 10 to 60 wt % of Kero (bp of 150 to 265° C.), 20 to 40 wt % of LGO (bp of 265 to 380° C.), and 5 to 40 wt % of UCO-2/AR (bp of 380° C. to 800° C.), and specifically, may include, with respect to the total weight of the pyrolysis gas, 5 to 30 wt % of Naphtha (bp of 36° C. to 150° C.), 15 to 50 wt % of Kero (bp of 150 to 265° C.), 20 to 35 wt % of LGO (bp of 265 to 380° C.), and 10 to 40 wt % of UCO-2/AR (bp of 380° C. to 800°), or 5 to 20 wt % of Naphtha (bp of 36° C. to 150° C.), 15 to 35 wt % of Kero (bp of 150 to 265° C.), 25 to 35 wt % of LGO (bp of 265 to 380° C.), and 15 to 40 wt % of UCO-2/AR (bp of 380° C. to 800° C.). In addition, in the pyrolysis gas, a weight ratio of light oils (the sum of Naphtha and Kero) to heavy oils (the sum of LGO and UCO-2/AR) may be 0.1 to 3, 0.1 to 2.0, or 0.2 to 1.0. When the pyrolysis gas having the above range of the oil composition is then introduced into a hot filter 20, the desired effect of lightening pyrolysis oil and removing impurities may be improved. Specifically, in the hot filter 20, as a pyrolysis reaction occurs primarily at a high temperature, additional chlorine dissociation and lightening of the pyrolysis oil proceed simultaneously, and secondarily, the dissociated chlorine comes into contact with a neutralizing agent (CaO) and is fixed in the form of salt. In particular, it is analyzed that the amount of HCl generated is large in pyrolysis oil derived from domestic waste plastic including PVC, and the HCl dissociated chlorine is not recombined with hydrocarbons and is fixed to the neutralizing agent (CaO) in the hot filter 20 at a high ratio. Accordingly, the pyrolysis operation of embodiments of the present disclosure may have better chlorine removal efficiency when using domestic waste plastic as a feedstock. However, in the case of industrial waste plastic, the chlorine removal efficiency may be somewhat low because the content of chlorine in the feedstock itself is lower than that of domestic waste plastic, but the lightening effect may be significantly improved due to a difference in the composition of waste plastics.

The pyrolysis operation may be performed in an autoclave reactor, a batch reactor, a fluidized-bed reactor, a packed-bed reactor, or the like, and specifically, any reactor capable of controlling stirring and temperature rise may be applied. In an embodiment, the pyrolysis operation may be performed in a batch reactor.

Meanwhile, the pyrolysis operation may further include a pyrolysis gas recovery operation of recovering a pyrolysis gas phase and a pyrolysis liquid phase as gas, and a separation operation of separating the pyrolysis solid phase (solids) into fine particles and coarse particles.

In the pyrolysis gas recovery operation, pyrolysis gas containing low-boiling-point hydrocarbon compounds such as methane (CH₄), ethane (C₂H₆), and propane (C₃H₈) in the gas phase generated in the pyrolysis operation is recovered. The pyrolysis gas generally contains combustible materials such as hydrogen, carbon monoxide, and low-molecular-weight hydrocarbon compounds. Examples of the hydrocarbon compounds include methane, ethane, ethylene, propane, propene, butane, and butene. Such pyrolysis gas contains a combustible material and may be used as fuel.

In the separation operation, solids in the solid phase generated in the pyrolysis operation, for example, carbides, a neutralizing agent, and/or a copper compound are separated into fine particles and coarse particles. Specifically, classification is performed using a sieve having a size smaller than an average particle diameter of the chlorine-containing plastics and larger than an average particle diameter of the neutralizing agent or the copper compound, such that the solids generated by the pyrolysis operation may be separated into fine particles and coarse particles. In the separation operation, it is preferable to separate the solids into fine particles containing a relatively large amount of the chlorine-containing neutralizing agent and the copper compound, and coarse particles containing a relatively large amount of carbides. The fine particles and carbides may be retreated as necessary, reused in the pyrolysis operation, used as fuel, or disposed of as waste, but the embodiments of the present disclosure are not limited thereto.

Subsequently, the operation S2 is an operation of producing waste plastic pyrolysis oil by introducing the pyrolysis gas into a hot filter filled with a neutralizing agent.

The production of the waste plastic pyrolysis oil in the operation S2 may be performed in an oxygen-free atmosphere at a temperature of 400 to 550° C. and a pressure of normal pressure to 0.5 bar, and the oxygen-free atmosphere may be an inert gas atmosphere or a closed system atmosphere without oxygen. In the above temperature range, lightening of the pyrolysis oil is performed well, such that clogging and a differential pressure caused by wax may be suppressed.

In addition, the production of the waste plastic pyrolysis oil in the operation S2 may be performed at a gas hourly space velocity (GHSV) of 0.3 to 1.2/hr or 0.5 to 0.8/hr. When the above condition is satisfied, the waste plastic pyrolysis oil may be lightened, and impurities in the pyrolysis oil may be reduced.

The neutralizing agent may be oxide, hydroxide, and carbonate of a metal, or a combination thereof, and the metal may be calcium, aluminum, magnesium, zinc, iron, copper, or a combination thereof. Specifically, the neutralizing agent may be aluminum oxide, calcium oxide, magnesium oxide, zinc oxide, iron oxide, and/or copper oxide. In addition, the neutralizing agent may be a zeolite component such as a waste fluid catalytic cracking (FCC) catalyst (E-cat), and may further contain a waste FCC catalyst in the metal oxide. Preferably, the neutralizing agent may be calcium oxide, a waste FCC catalyst, copper metal, or copper oxide, or may be calcium oxide.

The neutralizing agent may have a particle size of 400 to 900 μm, or may have a particle size of 500 to 800 μm. As the hot filter 20 is filled with the neutralizing agent having the above particle size, the GHSV of the pyrolysis gas is adjusted, such that the lightening of the pyrolysis oil may be achieved, and the differential pressure of the hot filter may be suppressed, which may improve the process operation efficiency.

The particle size of the neutralizing agent may refer to D50, and D50 refers to a particle diameter when a cumulative volume from a small particle size accounts for 50% in measuring a particle size distribution by a laser scattering method. In this case, as for D50, the particle size distribution may be measured by collecting the sample from the prepared carbonaceous material according to KS A ISO 13320-1 standard using Mastersizer 3000 manufactured by Malvern Panalytical Ltd. Specifically, ethanol may be used as a solvent, and if necessary, the ethanol is dispersed using an ultrasonic disperser, and then, a volume density may be measured.

The hot filter 20 generally serves to separate pyrolysis gas and a residue (char) among pyrolyzed products in the art. However, in the embodiments of the present disclosure, the hot filter filled with a neutralizing agent is applied not only to achieve lightening but also to reduce impurities, and therefore, as described above, operating conditions such as a temperature of the hot filter and a particle size of the neutralizing agent are adjusted to specific ranges.

The operation S2 may satisfy the following Relational Expressions 1 and 2.

$$50 < ( {A}_{2} - {A}_{1} ) / {A}_{1} ( \% ) < 100 \qquad Relational Expression 1$$

$$- 80 < ( {B}_{2} - {B}_{1} / {B}_{1} ) ( \% ) < - 50 \qquad Relational Expression 2$$

In Relational Expression 1, A₁ represents a total amount (wt %) of Naphtha (bp of 36° C. to 150° C.) and Kero (bp of 150 to 265° C.) of the pyrolysis gas, and A₂ represents a total amount (wt %) of Naphtha (bp of 36° C. to 150° C.) and Kero (bp of 150 to 265° C.) of the pyrolysis oil, and in Relational Expression 2, B₁ represents a content (ppm) of chlorine in the pyrolysis gas, and B₂ represents a content (ppm) of chlorine in the pyrolysis oil. Specifically, Relational Expressions 1 and 2 may be 60<(A₂−A₁)/A₁(%)<90, 65<(A₂−A₁)/A₁(%)<85, or 70<(A₂−A₁)/A₁ (%)<80, and −75<(B₂−B₁/B₁) (%)<−55, −70<(B₂−B₁/B₁) (%)<−55, or −65<(B₂−B₁/B₁) (%)<−55, respectively.

Relational Expressions 1 and 2 numerically represent light and heavy degrees of the waste plastic pyrolysis oil as the hot filter filled with the neutralizing agent of the present disclosure is used. In the embodiments of the present disclosure, the light degree of the pyrolysis oil may be improved to a significantly high level by controlling the oil composition and the content of chlorine of the pyrolysis oil introduced into the hot filter and the organic/inorganic materials containing chlorine.

The waste plastic pyrolysis oil produced in the operation S2 may include, with respect to the total weight of the waste plastic pyrolysis oil, 30 to 50 wt % of Naphtha (bp of 36° C. to 150° C.), 30 to 50 wt % of Kero (bp of 150 to 265° C.), 10 to 30 wt % of LGO (bp of 265 to 380° C.), and 0 to 10 wt % of UCO-2/AR (bp of 380° C. to 800° C.), and specifically, may include, with respect to the total weight of the waste plastic pyrolysis oil, 35 to 50 wt % of Naphtha (bp of 36° C. to 150° C.), 35 to 50 wt % of Kero (bp of 150 to 265° C.), 10 to 30 wt % of LGO (bp of 265 to 380° C.), and 0 to 8 wt % of UCO-2/AR (bp of 380° C. to 800° C.) or 35 to 45 wt % of Naphtha (bp of 36° C. to 150° C.), 35 to 45 wt % of Kero (bp of 150 to 265° C.), 10 to 20 wt % of LGO (bp of 265 to 380° C.), and 0 to 6 wt % of UCO-2/AR (bp of 380° C. to 800° C.). In addition, in the pyrolysis gas, a weight ratio of light oils (the sum of Naphtha and Kero) to heavy oils (the sum of LGO and UCO-2/AR) may be 2.5 to 5, 2.5 to 4, or 3 to 3.8.

In the method for producing syngas containing hydrogen from waste plastics according to an embodiment of the present disclosure, the operations S1 and S2 may satisfy the following Relational Expression 3.

$$0. 7 < {T}_{2} / {T}_{1} < 1.3 \qquad Relational Expression 3$$

In Relational Expression 3, T₁ is a temperature at which the waste plastics are pyrolyzed in the pyrolysis reactor in the operation S1, and T₂ is a temperature at which the waste plastic pyrolysis oil is produced in the hot filter in the operation S2.

When the T₂/T₁ value is 0.7 or less, a ratio of pyrolysis oil that is condensed in the hot filter and then circulated to the pyrolysis reactor increases, and thus, a final boiling point of the pyrolysis oil may be excessively low. On the other hand, when the T₂/T₁ value is 1.3 or more, a ratio of pyrolysis oil that is lost in the gas phase may excessively increase, and thus, a yield of pyrolysis oil may be reduced.

Specifically, the T₂/T₁ value may be, for example, 0.7 to 1.2, 0.8 to 1.2, 0.8 to 1.1, 0.9 to 1.1, or 1. Therefore, the effects described above may be further improved.

The operation S3 is an operation of applying a voltage to a first mixed solution obtained by mixing the waste plastic pyrolysis oil, washing water, and a demulsifier to dehydrate the first mixed solution.

Waste plastic pyrolysis oil contains moisture, and moisture in pyrolysis oil may cause issues such as deactivation of a hydrotreating catalyst and corrosion of a reactor. In addition, since water-soluble impurities are contained in moisture, it is required to remove moisture. Moisture present in the form of an emulsion in the waste plastic pyrolysis oil may be easily removed by performing the operation S3.

The waste plastic pyrolysis oil according to an embodiment of the present disclosure may contain impurities such as a chlorine compound, a nitrogen compound, an oxygen compound, a metal compound, and char-derived particles, may contain impurities in the form of compounds in which chlorine, nitrogen, oxygen, or a metal is bonded to hydrocarbons, and may contain paraffinic, olefinic, naphthenic, or aromatic hydrocarbons.

The washing water according to an embodiment of the present disclosure may serve to increase the probability of contact between emulsion-type moisture present in the waste plastic pyrolysis oil. In addition, a basic compound may be added to the washing water to remove a water-soluble acidic material contained in moisture, and the basic compound may be sodium hydroxide (NaOH), but the embodiments are not particularly limited thereto. The waste plastic pyrolysis oil according to an embodiment of the present disclosure may be mixed in a greater volume than the washing water, and specifically, the waste plastic pyrolysis oil and the washing water may be mixed in the first mixed solution at a volume ratio of 1:0.001 to 1:0.5, more specifically, 1:0.005 to 1:0.4, and most specifically, 1:0.01 to 1:0.3. When the volume ratio satisfies the above range, water washing is sufficiently performed, and thus, impurities in the pyrolysis oil may be significantly reduced, and costs required to remove washing water to be mixed may be minimized.

The demulsifier according to an embodiment of the present disclosure may be one or a mixture of two or more selected from the group consisting of polyethylene glycol, tert-butanol, acetone, alkylnaphthalene sulfonate, alkylbenzene sulfonate, a nonionic alkoxylated alkyl phenol resin, polyalkylene oxide, and polyoxyethylene sorbitan ester, but the embodiments are not limited thereto.

In the first mixed solution according to an embodiment of the present disclosure, the waste plastic pyrolysis oil and the demulsifier may be mixed at a volume ratio of 1:0.000001 to 1:0.001, specifically, 1:0.000002 to 1:0.0005, and more specifically, 1:0.000003 to 1:0.0001. When the volume ratio satisfies the above range, the emulsion may be decomposed with minimal impact on the quality of pyrolysis oil.

The demulsifier according to an embodiment of the present disclosure may have a weight average molecular weight of 200 to 2,000, specifically, 300 to 1,000, and more specifically, 400 to 800. When the weight average molecular weight satisfies the above range, it is easy to mix the demulsifier with the waste plastic pyrolysis oil and the washing water under conditions where the dehydration operation is performed, and thus, the decomposition efficiency of the moisture emulsion is increased.

The moisture in the form of an emulsion contained in the first mixed solution in which the waste plastic pyrolysis oil, the washing water, and the demulsifier are mixed is still difficult to remove because it is stable. Therefore, a voltage may be applied to the first mixed solution to facilitate removal of moisture.

The voltage according to an embodiment of the present disclosure may be applied as a dual polarity, alternating current, direct current or a combination of an alternating current and a direct current. Some impurity particles contained in the waste plastic pyrolysis oil have polarities, and therefore, when a direct current voltage is applied, polarized impurity particles accumulate on a specific electrode, and when the process is performed for a long period of time, the impurities may adhere to the electrode. However, when an alternating current voltage is applied, the polarity of the electrode changes periodically, and therefore, the adhesion phenomenon of the impurity particles may be prevented. In addition, a frequency of the alternating current according to an embodiment of the present disclosure may be a single frequency or a combination of two or more frequencies. As a specific example, in the case of the single frequency, an alternating current with a frequency of 60 Hz may be applied, and in the case of the combination of two or more frequencies, alternating currents with frequencies of 50 Hz and 60 Hz may be applied alternately, but the embodiments of the present disclosure are not limited thereto.

The voltage according to an embodiment of the present disclosure may be applied through one or more pairs of vertical electrodes. In a case where the impurity particles accumulate on the electrode during a mixed solution preparation process or a voltage application process, when the impurity particles are not artificially washed away, the impurity particles may adhere to the electrode after a long period of time. However, when one or more pairs of vertical electrodes is used, the adhesion phenomenon of the impurity particles may be prevented in advance because the impurity particles do not accumulate on the electrode but fall to the bottom of the reactor due to gravity even without an additional washing operation.

A magnitude of the voltage according to an embodiment of the present disclosure may be 0.1 to 50 kV, specifically, 1 to 30 kV, and more specifically, 5 to 20 kV, but the embodiments are not limited thereto.

The dehydration according to an embodiment of the present disclosure may be performed by any method known in the art. As a non-limiting example, after the application of the voltage, water may be removed by draining a water layer which is oil-water separated. Water may also be removed in a gas-liquid separator.

Metal impurities in the waste plastic pyrolysis oil stabilize the emulsion, hinder oil-water separation, and help form a stable emulsion layer, commonly called a rag layer. Such a rag layer may be formed between a desalinated oil layer at an upper portion of the first mixed solution and a water layer at a lower portion of the first mixed solution, and may be gradually thickened during a continuous dehydration operation. An excessively thickened rag layer may be discharged to an equipment at the hydrotreating operation together with desalinated oil. This reduces the desalination effect of the desalinated oil and reduces the efficiency of the process. In addition, the rag layer may be discharged together with water and may cause complications in a wastewater treatment process. Therefore, it is preferable to remove the rag layer formed between the desalinated oil layer and the water layer.

Therefore, the method for producing syngas containing hydrogen from waste plastics according to an embodiment of the present disclosure may further include, after the application of the voltage in the operation S3, removing a rag layer from the first mixed solution. The removal of the rag layer may be performed through a pipe penetrating through a wall of a dehydrator 30 and connected to the outside after measuring a change in density of the mixed solution by a density meter in the dehydrator to determine a formation location and a thickness of the rag layer, but the embodiments are not limited thereto. In the operation S3 according to an embodiment of the present disclosure, after dehydrating the first mixed solution, the dehydrated first mixed solution may be additionally dehydrated by condensation of moisture.

The additional dehydration according to an embodiment of the present disclosure may be performed by supplying the dehydrated first mixed solution to a coalescer 32. Specifically, the residual moisture contained in the dehydrated first mixed solution 34 may be removed through condensation by a collection filter in the coalescer 32, but this is only a specific example and the embodiments of the present disclosure are not limited thereto. As the content of moisture in the waste plastic pyrolysis oil is further reduced through the additional dehydration, deactivation of the catalyst due to moisture may be prevented, and the process stability and the quality of refined oil may be improved.

A ratio of a content of moisture in the waste plastic pyrolysis oil to a content of moisture in the dehydrated first mixed solution according to an embodiment of the present disclosure may be 1:0.0001 to 1:0.9, specifically, 1:0.0005 to 1:0.5, and more specifically, 1:0.001 to 1:0.1. When the ratio satisfies the above range, a risk of trouble occurring in subsequent processes such as hydrotreating may be significantly reduced, and high-quality refined oil that meets specifications may be produced as a feedstock, but the embodiments of the present disclosure are not limited thereto.

The operation S3 according to an embodiment of the present disclosure may be performed at a pressure of 50 bar or less. When the operation S3 is performed at a pressure of 50 bar or less, moisture in the pyrolysis oil may be easily removed, and the process stability may be secured. Specifically, the operation S3 may be performed at a pressure of 30 bar or less, more specifically, 20 bar or less, and without limitation, 5 bar or more.

The operation S3 according to an embodiment of the present disclosure may be performed at a temperature of 20° C. to 300° C. When the temperature satisfies the above range, the decomposition of the emulsion and the condensation of moisture are smoothly performed, and thus, the dehydration efficiency may be improved. Specifically, the operation S3 may be performed at a temperature of 50° C. to 250° C., and more specifically, 80° C. to 200° C.

To improve the dehydration efficiency in the operation S3 according to an embodiment of the present disclosure, one or more additional processes selected from the group consisting of centrifugation and distillation may be performed before and/or after the dehydration. The additional processes described above may be performed by a method known in the art, but are not particularly limited thereto.

Next, the operation S4 is an operation of hydrotreating a second mixed solution obtained by mixing the first mixed solution dehydrated in the operation S3 and a sulfur source 38 to produce refined oil 46 from which impurities are removed. The second mixed solution according to an embodiment of the present disclosure may have a concentration of chlorine (Cl) of 10 ppm or more, specifically, 100 ppm or more, more specifically, 200 ppm or more, and without limitation, 3,000 ppm or less as an upper limit, but the embodiments are not limited thereto. In the second mixed solution according to an embodiment of the present disclosure, a weight ratio of nitrogen to chlorine may be 1:0.1 to 1:10, specifically, 1:0.5 to 1:5, and more specifically, 1:1 to 1:2, but the above weight ratio is only a specific example of what may be included in the waste plastic pyrolysis oil, and a composition of the waste plastic pyrolysis oil is not limited thereto.

The hydrotreating according to an embodiment of the present disclosure may be performed under a condition in which a ratio of hydrogen to the second mixed solution is 100 Nm³/Sm³ to 5,000 Nm³/Sm³, specifically, 500 Nm³/Sm³ to 3,000 Nm³/Sm³, and more specifically, 1,000 Nm³/Sm³ to 1,500 Nm³/Sm³. When this condition is satisfied, impurities may be effectively removed, the high activity of the hydrotreating catalyst may be maintained for a long period of time, and the process efficiency may be improved. The sulfur source 38 refers to a sulfur source capable of continuously supplying a sulfur component during the refining process.

In the operation S4, the second mixed solution containing the sulfur source 38 is prepared, such that during the refining process, deactivation of a molybdenum-based hydrotreating catalyst due to lack of the sulfur source and high-temperature operation may be suppressed, and the catalytic activity may be maintained.

The sulfur source 38 according to an embodiment of the present disclosure may include sulfur-containing oil. The sulfur-containing oil refers to oil composed of hydrocarbons containing sulfur obtained from crude oil as a feedstock. The sulfur-containing oil is not particularly limited as long as it is oil containing sulfur, and the sulfur-containing oil may be, for example, light gas oil, straight-run naphtha, vacuum naphtha, pyrolysis naphtha, straight-run kerosene, vacuum kerosene, pyrolysis kerosene, straight-run gas oil, vacuum gas oil, pyrolysis gas oil, sulfur-containing waste tire oil, and any mixture thereof.

When waste tire oil is included as the sulfur-containing oil according to an embodiment of the present disclosure, a high content of sulfur contained in waste tires may be converted into oil together with hydrocarbons and may preferably serve as a sulfur source for the waste plastic pyrolysis oil. In addition, diverting the waste tire oil into the sulfur source for the waste plastic pyrolysis oil is advantageous in terms of reducing the environmental load due to recycling of waste tires and maintaining the catalytic activity for a long period of time. Specifically, the sulfur-containing oil may be light gas oil (LGO) with a specific gravity of 0.7 to 1. When this sulfur-containing oil is used, the sulfur-containing oil may be uniformly mixed with the dehydrated first mixed solution, and high hydrotreating efficiency may be exhibited. Specifically, the specific gravity may be 0.75 to 0.95, and more specifically, 0.8 to 0.9. The sulfur-containing oil may contain 100 ppm or more of sulfur. When the sulfur component is contained in an amount of less than 100 ppm, a content of the sulfur component supplied is small, such that the effect of preventing deactivation of the molybdenum-based hydrotreating catalyst may be insufficient. Specifically, the sulfur component may be contained in an amount of 800 ppm or more, more specifically, 8,000 ppm or more, and without limitation, 200,000 ppm or less. The second mixed solution according to an embodiment of the present disclosure may contain 100 ppm or more of sulfur. As in the case of the sulfur-containing oil, when the sulfur component is contained in the second mixed solution in an amount of less than 100 ppm, the content of the sulfur component supplied is small, such that the effect of preventing deactivation of the molybdenum-based hydrotreating catalyst may be insufficient. Specifically, the sulfur component may be contained in an amount of 800 ppm or more, more specifically, 8,000 ppm or more, and without limitation, 200,000 ppm or less. The sulfur-containing oil according to an embodiment of the present disclosure may be included in an amount of less than 0.5 parts by weight with respect to 100 parts by weight of the first mixed solution dehydrated in the operation S3. Specifically, the sulfur-containing oil may be included in an amount of less than 0.1 parts by weight, more specifically, less than 0.05 parts by weight, and without limitation, more than 0.01 parts by weight. As the sulfur-containing oil is included in an amount of less than 0.5 parts by weight, the concentration of chlorine (Cl) or nitrogen (N) contained in the waste plastic pyrolysis oil is diluted, such that a formation rate of an ammonium chloride salt (NH₄Cl) may be controlled, and the process stability may be improved.

The sulfur source according to an embodiment of the present disclosure may include one or two or more sulfur-containing organic compounds selected from a disulfide-based compound, a sulfide-based compound, a sulfonate-based compound, and a sulfate-based compound. Specifically, the sulfur source may include one or a mixture of two or more selected from dimethyl disulfide, dimethyl sulfide, polysulfide, dimethyl sulfoxide (DMSO), methyl methanesulfonate, ethyl methanesulfonate, propyl methanesulfonate, propenyl propenesulfonate, propenyl cyanoethansulfonate, ethylene sulfate, bicyclo-glyoxal sulfate, and methyl sulfate. However, these compounds are only presented as examples and the embodiments of the present disclosure are not limited thereto.

The sulfur-containing organic compound according to an embodiment of the present disclosure may be included in an amount of 0.01 to 0.1 parts by weight with respect to 100 parts by weight of the first mixed solution dehydrated in the operation S3. Specifically, the sulfur-containing organic compound may be included in an amount of 0.02 to 0.08 parts by weight, and more specifically, 0.03 to 0.06 parts by weight. When the sulfur-containing organic compound is included in an amount of less than 0.01 parts by weight, the content of the sulfur component supplied is small, such that the effect of preventing deactivation of the molybdenum-based hydrotreating catalyst may be insufficient.

The hydrotreating refers to a hydrogenation reaction that occurs by adding a reaction gas including hydrogen gas (H₂) 37 to the second mixed solution in which the first mixed solution dehydrated in the operation S3 and the sulfur source are mixed in the presence of a molybdenum-based hydrotreating catalyst. Specifically, the hydrotreating may refer to hydrotreating, which is known in the related art, including a hydrodesulfurization reaction, a hydrocracking reaction, a hydrodechlorination reaction, a hydrodenitrogenation reaction, a hydrodeoxygenation reaction, and a hydrodemetallization reaction. Through the hydrotreating, impurities including chlorine (Cl), nitrogen (N), and oxygen (O), and some olefins may be removed, other metal impurities may also be removed, and a by-product containing the impurities is produced.

The by-product is produced by reacting impurities such as chlorine (Cl), nitrogen (N), sulfur (S), or oxygen (O) contained in the waste plastic pyrolysis oil with hydrogen gas (H₂). Specifically, the by-product may include hydrogen sulfide gas (H₂S), hydrogen chloride (HCl), ammonia (NH₃), water vapor (H₂O), or the like, and in addition, may include unreacted hydrogen gas (H₂), and a trace of methane (CH₄), ethane (C₂H₆), propane (C₃H₈), butane (C₄H₁₀), or the like.

The molybdenum-based hydrotreating catalyst according to an embodiment of the present disclosure may be a catalyst in which a molybdenum-based metal, or a metal including one or two or more selected from nickel, cobalt, and tungsten, and a molybdenum-based metal are supported on a support. The molybdenum-based hydrotreating catalyst has high catalytic activity during hydrotreating, and the molybdenum-based hydrotreating catalysts may be used alone or, if necessary, in the form of a two-way catalyst combined with a metal such as nickel, cobalt, or tungsten.

As the support according to an embodiment of the present disclosure, alumina, silica, silica-alumina, titanium oxide, a molecular sieve, zirconia, aluminum phosphate, carbon, niobia, or a mixture thereof may be used, but the embodiments of the present disclosure are not limited thereto.

The molybdenum-based hydrotreating catalyst according to an embodiment of the present disclosure may include a molybdenum-based sulfide hydrotreating catalyst. For example, the molybdenum-based hydrotreating catalyst may include molybdenum sulfide (MoS) or molybdenum disulfide (MoS2, but the embodiment is not limited thereto, and may include a known molybdenum-based sulfide hydrotreating catalyst.

The reaction gas according to an embodiment of the present disclosure may further include hydrogen sulfide gas (H₂S). The hydrogen sulfide gas (H₂S) included in the reaction gas may act as a sulfur source, and may regenerate the activity of the molybdenum-based hydrotreating catalyst deactivated during the refining process together with the sulfur source mixed with the waste plastic pyrolysis oil.

The hydrotreating according to an embodiment of the present disclosure may be performed at a pressure of 150 bar or less. Specifically, the hydrotreating may be performed at a pressure of 120 or less, more specifically, 100 bar or less, and without limitation, 50 bar or more. When the hydrotreating is performed under a pressure condition of more than 150 bar, as ammonia and hydrogen chloride are produced in excess during the hydrotreating, an ammonium chloride salt formation temperature increases, and as a result, a differential pressure of a reactor or the like in the process may be easily caused, and the process stability may be significantly reduced. By controlling the contents of nitrogen and chlorine in the waste plastic pyrolysis oil, the increase in ammonium chloride salt formation temperature may be partially suppressed even under a condition of a pressure of more than 150 bar. However, this case is not appropriate because the waste plastics targeted in the production method according to the present disclosure may be extremely limited thereto.

The hydrotreating according to an embodiment of the present disclosure may be performed at a temperature of 150° C. to 500° C. When the temperature satisfies the above range, the hydrotreating efficiency may be improved. Specifically, the hydrotreating may be performed at a temperature of 200° C. to 400° C.

The hydrotreating according to an embodiment of the present disclosure may be performed in multiple stages, and as a specific example, may be performed in two stages. When the hydrotreating is performed in two stages, a first stage may be performed at a lower temperature than a second stage. In this case, the first stage may be performed at a temperature of 150° C. to 300° C., and specifically, 200° C. to 250° C., and the second stage may be performed at a temperature of 300° C. to 500° C., and specifically, 350° C. to 400° C., but the embodiments of the present disclosure are not limited thereto.

The method for producing syngas containing hydrogen from waste plastics according to an embodiment of the present disclosure may further include, after the operation S4, subjecting a stream including the refined oil from which impurities are removed to gas-liquid separation and then washing the gas-liquid separated stream with water.

The stream including the refined oil from which impurities are removed according to an embodiment of the present disclosure may contain hydrogen chloride, ammonia, unreacted hydrogen gas, and the like, in addition to the refined oil from which impurities are removed, which is discharged from a rear end of the reactor where the operation S4 is performed.

Through the gas-liquid separation according to an embodiment of the present disclosure, from the stream including the refined oil from which impurities are removed, ammonia and hydrogen chloride produced by the hydrotreating may be removed, and unreacted hydrogen gas may be recovered.

The gas-liquid separation according to an embodiment of the present disclosure may be performed by a method known in the art using a separator, but the embodiments are not particularly limited.

The gas-liquid separation according to an embodiment of the present disclosure may be performed two to four times, specifically, three or four times, and more specifically, four times. When the above range is satisfied, the formation of the ammonium chloride salt may be minimized even under a low-temperature condition for oil-water separation because the refined oil contains traces of NH₃ and HCl. In addition, oil refining and petrochemical processes using the refined oil as a feedstock may be stably performed without adding an additional salt remover to the refined oil later.

A gas stream produced as a result of the gas-liquid separation according to an embodiment of the present disclosure may include off-gas containing light hydrocarbons, hydrogen sulfide, ammonia, hydrogen chloride, or the like, and unreacted hydrogen gas. According to a method known in the art, the off-gas and the unreacted hydrogen gas are separated, the separated unreacted hydrogen gas is recirculated in the process, and the off-gas is treated through an operation described below and may be used as a feedstock or discharged into the atmosphere.

Through the water washing according to an embodiment of the present disclosure, a salt included in the gas stream may be dissolved and removed, or salt formation may be suppressed by dissolving gas that may form a salt. The water washing may be performed by a method known in the art, but the embodiments are not particularly limited.

The water washing according to an embodiment of the present disclosure may be performed two to four times, and specifically, two or three times. When the above range is satisfied, the salt removal and salt formation suppression effect may be sufficiently exhibited, such that high-quality refined oil may be obtained, and the process stability may be secured.

The method for producing syngas 52 containing hydrogen from waste plastics 2 according to an embodiment of the present disclosure may further include, after the subjecting of the stream including the refined oil from which impurities are removed to the gas-liquid separation and then the washing of the gas-liquid separated stream with water: combusting the separated off-gas 44; and processing uncombusted off-gas 44.

The off-gas according to an embodiment of the present disclosure may contain C1-C4 light hydrocarbons, hydrogen sulfide (H₂S), ammonia (NH₃), and the like. Therefore, to use the off-gas as fuel, it is required to combust the off-gas to remove hydrogen sulfide (H₂S), ammonia (NH₃), and the like. Exhaust gas containing sulfur dioxide (SO₂), nitrogen dioxide (NO₂), and the like, produced by combustion of the off-gas may be discharged into the atmosphere after performing caustic scrubbing to meet emission standards.

In addition, after combusting the separated off-gas, uncombusted off-gas may be discharged as wastewater by being subjected to sour water stripping, adsorption, biological treatment, oxidation, amine scrubbing, or caustic scrubbing.

Next, the operation S5 is an operation of gasifying the refined oil 46 from which impurities are removed.

In the present disclosure, “gasification” refers to a thermo-chemical conversion operation through changes in chemical structures of carbonaceous materials in the presence of a gasifying agent (air, oxygen, water vapor, carbon dioxide, or a mixture thereof) in a broad sense, and refers to an operation of converting carbonaceous materials into syngas mainly containing hydrogen and carbon monoxide in a narrower sense.

The gasification according to an embodiment of the present disclosure may typically produce syngas which may consist of hydrogen and carbon monoxide, and may contain a small amount of carbon dioxide, through a water vapor gasification reaction and/or a carbon dioxide gasification reaction according to the following Reaction Formulas 1 and 2.

C+H₂O→CO+H₂ [Reaction Formula 1]

C+CO₂→2CO [Reaction Formula 2]

The gasification according to an embodiment of the present disclosure may be performed using a gasification reactor known in the art. For example, the water vapor gasification reaction may be performed using a counter-current fixed bed reactor, a co-current fixed bed reactor, a fluidized bed reactor, a moving bed reactor, an entrained bed reactor, or the like. In addition, in the case of the carbon dioxide gasification reaction, for example, a fluidized bed reactor may be used, and examples of the fluidized bed reactor include a riser, bubbling, or turbulent type reactor. However, the type and detailed configuration of the reactor may be appropriately selected or adjusted from various gasification reactors known in the art depending on an intended gasification reaction route, for example, the water vapor gasification reaction, the carbon dioxide gasification reaction, or both reactions. In addition, reaction conditions may also be appropriately selected considering the target reaction route and the like.

The gasification according to an embodiment of the present disclosure may be performed at a temperature of 400 to 1,200° C., specifically, 500 to 1,000° C., and more specifically, 550 to 800° C., but the embodiments are not limited thereto.

The gasification according to an embodiment of the present disclosure is not particularly limited, and may be performed at a pressure of, for example, 1 to 50 bar, and more specifically, 1 to 5 bar. In this case, the reaction gas mainly contains water vapor, but may optionally contain oxygen or air, for example, through air blowing, and furthermore, may contain a small amount of carbon dioxide. In some cases, the amount of water vapor in a reaction region may be controlled by controlling a partial pressure using an inert gas such as nitrogen or argon. In this case, a supply ratio of water vapor/carbon may be, for example, within 4, specifically, 0.1 to 3, and more specifically, 0.5 to 2, on a molar basis.

In the operation S5 according to an embodiment of the present disclosure, a refined fraction separated by distilling the refined oil from which impurities are removed may be gasified. The refined fraction according to an embodiment of the present disclosure may be at least one selected from the group consisting of naphtha, kerosene, light gas oil, vacuum gas oil (VGO), and residue, but the embodiments are not limited thereto.

In the operation S5 according to an embodiment of the present disclosure, mixed oil obtained by mixing the refined oil from which impurities are removed and petroleum hydrocarbons may be gasified. In addition, mixed oil obtained by mixing the refined fraction and petroleum hydrocarbons may also be gasified.

The petroleum hydrocarbon refers to a mixture of naturally occurring hydrocarbons or a compound separated from the mixture, and specific examples thereof include, but are not limited to, one or a mixture of two or more selected from the group consisting of kerosene, light gas oil, heavy gas oil, and vacuum gas oil (VGO) derived from crude oil.

The mixed oil according to an embodiment of the present disclosure may include the refined oil from which impurities are removed in an amount of 5 wt % or more, 10 wt % or more, 20 wt % or more, 40 wt % or more, or 50 wt % or more, with respect to the total weight of the mixed oil, and an upper limit of the content of the refined oil from which impurities are removed may be 95 wt % or less, but the embodiments are not limited thereto. The embodiments of the present disclosure are not limited to the above range. However, in general, the lower the content of impurities in the refined oil, the higher the proportion of refined oil that may be included in the mixed oil.

In addition, the embodiments of the present disclosure provide a system for producing syngas containing hydrogen from waste plastics, the system including: a pyrolysis reactor 10 for producing pyrolysis gas 12 from waste plastics 2; a hot filter 20 into which the pyrolysis gas is introduced and in which waste plastic pyrolysis oil 24 is produced; a dehydrator 30 performing dehydration by applying a voltage to a first mixed solution obtained by mixing the waste plastic pyrolysis oil 24, washing water 26, and a demulsifier 28; a hydrotreating reactor 40 into which the first mixed solution dehydrated in the dehydrator and hydrogen gas are introduced and in which refined oil from which impurities are removed is produced by hydrotreating the first mixed solution in the presence of a hydrotreating catalyst; and a gasification reactor 50 for gasifying the refined oil from which impurities are removed.

The contents described for the method for producing syngas containing hydrogen from waste plastics may be equally applied to the description of the system for producing syngas containing hydrogen from waste plastics to the extent of overlap.

The dehydrator according to an embodiment of the present disclosure may be provided with one or more pairs of vertical electrodes. The number of vertical electrodes provided in the dehydrator according to an embodiment of the present disclosure may be at least two, specifically, four or more, more specifically, six or more, and as an upper limit, twenty or fewer, but the embodiments are not limited thereto.

The dehydrator 30 according to an embodiment of the present disclosure may include a coalescer 32 therein. The coalescer 32 is a device that collects fine droplets to form large droplets, and any device commonly used in the industry may be used. The coalescer is not particularly limited.

The first mixed solution dehydrated in the dehydrator 30 may be introduced into the coalescer 32 according to an embodiment of the present disclosure, and an additionally dehydrated first mixed solution may be produced. When a dehydrator including the coalescer is used, the additionally dehydrated first mixed solution 34 is also introduced into the hydrotreating reactor 40 together with the hydrogen gas 37.

The system for producing syngas 52 containing hydrogen from waste plastics 2 according to an embodiment of the present disclosure may further include a separator (see separators 42-1 to 42-4) for subjecting the refined oil from which impurities are removed to gas-liquid separation, the refined oil being produced in the hydrotreating reactor.

The number of separators according to an embodiment of the present disclosure may be two to four, specifically, three or four, and more specifically, four. When the above range is satisfied, the formation of the ammonium chloride salt may be minimized even under a low-temperature condition for oil-water separation because the refined oil contains traces of NH₃ and HCl. In addition, oil refining and petrochemical processes using the refined oil as a feedstock may be stably performed without adding an additional salt remover to the refined oil later.

The system for producing syngas containing hydrogen from waste plastics according to an embodiment of the present disclosure may further include a recycle gas compressor recovering unreacted hydrogen gas from the separated gas stream from the separator and introducing the recovered unreacted hydrogen gas 36 (referred to also as recycle gas) into the hydrotreating reactor 40.

Hereinafter, the method and system for producing syngas containing hydrogen from waste plastics according to the embodiments of the present disclosure will be described in more detail with reference to Examples. However, the following Examples are only reference examples for describing the embodiments of the present disclosure in detail, and the embodiments are not limited thereto and may be implemented in various forms. Unless otherwise defined, all technical terms and scientific terms used herein have the same meaning as commonly understood by those skilled in the art to which the present disclosure pertains. In addition, the terms used in the present disclosure are only to effectively describe specific Examples, but are not intended to limit the embodiments of the present disclosure.

### Example 1

73.4 wt % of PE, 10.4 wt % of PP, 9.8 wt % of PVC, 2.3 wt % of PET, 2.1 wt % of nylon, and 2.0 wt % of PU were included in domestic waste plastic used as a feedstock.

600 g of the domestic waste plastic feed was introduced into a batch pyrolysis reactor, and pyrolysis was performed at 500° C. The produced pyrolysis gas was introduced into a hot filter at 500° C. filled with 20 g of CaO having a particle size (D50) of 400 to 900 μm, collected in a condenser, and recovered in a recovery unit as waste plastic pyrolysis oil.

The waste plastic pyrolysis oil, washing water, and polyethylene glycol having a weight average molecular weight of 500 were introduced into a dehydrator under conditions of 150° C. and 10 bar at a volume ratio of 1:0.25:0.0001, and stirring was performed, thereby preparing a first mixed solution. The first mixed solution was separated into oil and water by applying an alternating current voltage of 15 kV through a pair of vertical electrodes, and dehydration was performed by removing the water layer.

At this time, in the waste plastic pyrolysis oil, the content of moisture was about 5,000 ppm or more, and impurities at high concentrations of 500 ppm or more of nitrogen (N), 200 ppm or more of chlorine (Cl), and 20 vol % or more of olefins were contained.

A second mixed solution was prepared by mixing dimethyl disulfide in an amount of 0.04 parts by weight with respect to 100 parts by weight of the first mixed solution dehydrated in the dehydrator, and then the second mixed solution was hydrotreated under conditions of 300° C. and 70 bar, thereby producing refined oil from which impurities were removed.

Mixed oil obtained by mixing the refined oil from which impurities were removed and atmospheric residue having a boiling point of 380° C. or higher derived from crude oil at a weight ratio of 1:1 was gasified under conditions of 600° C. and 2 bar, thereby obtaining syngas containing hydrogen.

### Examples 2 and 3

Syngas containing hydrogen was obtained under the same conditions as those in Example 1, except that the waste plastic pyrolysis oil, washing water, and polyethylene glycol were introduced into the dehydrator at the volume ratio shown in Table 1.

### Example 4

Syngas containing hydrogen was obtained under the same conditions as those in Example 1, except that a direct current voltage was applied through a horizontal electrode.

### Example 5

Syngas containing hydrogen was obtained under the same conditions as those in Example 1, except that the dehydration of the first mixed solution was performed under a temperature condition of 120° C.

### Example 6

Syngas containing hydrogen was obtained under the same conditions as those in Example 1, except that the waste plastic pyrolysis oil and polyethylene glycol were introduced at a volume ratio of 1:0.00001 and the hydrotreating was performed under a condition of a pressure of 180 bar.

### Example 7

Syngas containing hydrogen was obtained under the same conditions as those in Example 1, except that after the first mixed solution was dehydrated, the first mixed solution was additionally dehydrated through a coalescer.

### Comparative Example 1

Syngas containing hydrogen was obtained under the same conditions as those in Example 1, except that washing water was not introduced.

### Comparative Example 2

Syngas containing hydrogen was obtained under the same conditions as those in Example 1, except that polyethylene glycol was not introduced.

### Comparative Example 3

Syngas containing hydrogen was obtained under the same conditions as those in Example 1, except that a voltage was not applied in Example 1.

### Comparative Example 4

Syngas containing hydrogen was obtained under the same conditions as those in Example 1, except that dimethyl disulfide was not mixed with the dehydrated first mixed solution.

### Evaluation Examples

### Measurement Methods

After the dehydration operation was completed, the contents of moisture and chlorine in the obtained mixed solution and the content of chlorine in the refined oil from which impurities were removed were measured through ICP and XRF analysis methods, and the measured results were shown.

A catalytic activity duration was measured and expressed in hours based on the time point when the content of nitrogen in the refined oil exceeded 10 ppm by performing Total Nitrogen & Sulfur (TNS element) analysis on the refined oil.

In addition, each of the Examples and Comparative Examples was operated for three months, and a particle adhesion rate was measured according to the following Equation 1.

$$Particle adhesion rate ( \% ) = ( Amount of impurity particles adhering to electrode / Amount of impurity particles in pyrolysis oil ) \times 100 \qquad [ Equation 1 ]$$

The measurement results are shown in Table 1.

TABLE 1

| | | | Example | Example | Example | Example | Example | Example |
|---|---|---|---|---|---|---|---|---|
| | | | 1 | 2 | 3 | 4 | 5 | 6 |
| Dehydration | Washing water | | 0.25 | 0.50 | 0.25 | 0.25 | 0.25 | 0.25 |
| | (volume ratio) | | | | | | | |
| | Demulsifier | | 0.0001 | 0.0001 | 0.00001 | 0.0001 | 0.0001 | 0.00001 |
| | (volume ratio) | | | | | | | |
| | Temperature | | 150 | 150 | 150 | 150 | 120 | 120 |
| | (° C.) | | | | | | | |
| | Pressure | | 10 | 10 | 10 | 10 | 10 | 10 |
| | (bar) | | | | | | | |
| | Voltage | Type | AC | AC | AC | DC | AC | AC |
| | | Electrode | Vertical | Vertical | Vertical | Horizontal | Vertical | Vertical |

| | | | | | | | |
|---|---|---|---|---|---|---|---|
| | Presence or absence | X | X | X | X | X | X |
| | of coalescer | | | | | | |
| Hydrotreating | Whether sulfur source | ◯ | ◯ | ◯ | ◯ | ◯ | ◯ |
| | is mixed or not | | | | | | |
| | Temperature | 300 | 300 | 300 | 300 | 300 | 300 |
| | (° C.) | | | | | | |
| | Pressure | 70 | 70 | 70 | 70 | 70 | 180 |
| | (bar) | | | | | | |

| | | | | | | |
|---|---|---|---|---|---|---|
| Content of moisture after dehydration | 556 | 743 | 618 | 559 | 678 | 850 |
| (ppm) | | | | | | |
| Content of Cl after dehydration | 528 | 522 | 570 | 529 | 605 | 703 |
| (ppm) | | | | | | |
| Catalytic activity duration | >720 | >720 | >720 | >720 | >720 | >720 |
| (hr) | | | | | | |
| Content of Cl in refined oil | <1 | <1 | <1 | <1 | <1 | <1 |
| (ppm) | | | | | | |
| Particle adhesion rate | 0.20 | 0.20 | 0.19 | 3.3 | 0.20 | 0.19 |
| (%) | | | | | | |

| | | Example | Comparative | Comparative | Comparative | Comparative |
|---|---|---|---|---|---|---|
| | | 7 | Example 1 | Example 2 | Example 3 | Example 4 |
| Dehydration | Washing water | 0.25 | — | 0.25 | 0.25 | 0.25 |
| | (volume ratio) | | | | | |
| | Demulsifier | 0.0001 | 0.0001 | — | 0.0001 | 0.0001 |
| | (volume ratio) | | | | | |
| | Temperature | 150 | 150 | 150 | 150 | 150 |
| | (° C.) | | | | | |
| | Pressure | 10 | 10 | 10 | 10 | 10 |
| | (bar) | | | | | |

| | | | | | | |
|---|---|---|---|---|---|---|
| Voltage | Type | AC | AC | AC | — | AC |
| | Electrode | Vertical | Vertical | Vertical | — | Vertical |

| | | | | | | |
|---|---|---|---|---|---|---|
| | Presence or absence | ◯ | X | X | X | X |
| | of coalescer | | | | | |
| Hydrotreating | Whether sulfur source | ◯ | ◯ | ◯ | ◯ | X |
| | is mixed or not | | | | | |
| | Temperature | 300 | 300 | 300 | 300 | 300 |
| | (° C.) | | | | | |
| | Pressure | 70 | 70 | 70 | 70 | 70 |
| | (bar) | | | | | |

| | | | | | |
|---|---|---|---|---|---|
| Content of moisture after dehydration | 474 | 2283 | 4011 | 3570 | 578 |
| (ppm) | | | | | |
| Content of Cl after dehydration | 442 | 920 | 1008 | 1030 | 532 |
| (ppm) | | | | | |
| Catalytic activity duration | >720 | <576 | <576 | <576 | <336 |
| (hr) | | | | | |
| Content of Cl in refined oil | <1 | 12.7 | 16.4 | 15.5 | 11.1 |
| (ppm) | | | | | |
| Particle adhesion rate | 0.18 | 0.24 | 0.23 | — | 0.20 |
| (%) | | | | | |

As shown in Table 1, in Comparative Examples 1 to 3, the introduction of washing water, introduction of demulsifier, and application of voltage were set differently from the Examples, and as a result, the effect of removing moisture and Cl by the dehydration operation was poor. As waste plastic pyrolysis oil containing a large amount of impurities was hydrotreated, the content of Cl in the refined oil was high, and the hydrotreating catalyst was deactivated relatively quickly. In Comparative Example 4, it was confirmed that although moisture and some impurities in the waste plastic pyrolysis oil were sufficiently removed in the dehydration operation, the hydrotreating catalyst was deactivated within a short time due to an insufficient content of sulfur, and thus, when the process was maintained for a long period time, the content of Cl in the refined oil was high as in other Comparative Examples. It may be expected that the content of refined oil in the gasified mixed oil is inevitably limited because Cl contained in a large amount in the refined oil may cause corrosion of the gasification reactor.

However, in Examples 1 to 7 according to the method for producing syngas containing hydrogen from waste plastics of the present disclosure, a significant amount of moisture contained in the waste plastic pyrolysis oil was removed through the dehydration operation, and a sulfur source was added, and as a result, the activity of the hydrotreating catalyst was maintained for a remarkably long time. In addition, since some water-soluble impurities were preemptively removed in the dehydration operation and hydrotreating was performed, a content of impurities such as Cl in the refined oil was low. Therefore, it was confirmed that a large amount of refined oil was added in the gasification operation even when the impurities were not additionally removed.

When an alternating current voltage was applied using one or more pairs of vertical electrodes, it was confirmed that the adhesion rate of impurity particles derived from char in the pyrolysis oil to the electrode surface was significantly low even when the process was continued for longer than three months. Through this, it was appreciated that when an alternating current voltage was applied or one or more pairs of vertical electrodes was used, there was no need to stop the process for washing the inside of the reactor, and as a result, more excellent process efficiency was exhibited.

In addition, in the case of Example 6, although the dehydration result was poor compared to other Examples, the content of Cl impurities in the refined oil was significantly low as the hydrotreating was performed under a high pressure condition. However, since ammonia and hydrogen chloride were produced in excess due to the high pressure, it was confirmed that a relatively large amount of ammonium chloride salt was formed even at the temperature at which the hydrotreating was performed. In Example 7, as the additional dehydration was performed using a coalescer, the contents of moisture and chlorine after the dehydration were lower than those in other Examples. Therefore, it may be expected that the activation time of the catalyst, the process stability, and the quality of refined oil are relatively superior to those in other Examples.

As set forth above, the method and system for producing syngas containing hydrogen from waste plastics according to the embodiments of the present disclosure may prevent or minimize formation of an ammonium chloride salt (NH₄Cl) and may prevent the adhesion phenomenon of impurity particles in a refining process of waste plastic pyrolysis oil containing impurities including chlorine and nitrogen.

The method and system for producing syngas containing hydrogen from waste plastics according to the embodiments of the present disclosure may prevent deactivation of the catalyst due to moisture, such that the refining efficiency may be excellent, and the process may be operated for a long period of time.

In the method and system for producing syngas containing hydrogen from waste plastics according to embodiments of the present disclosure, pyrolysis oil that may be blended with existing petroleum products in large quantities due to a significantly low content of impurities such as chlorine, nitrogen, oxygen, and metals and a significantly low content of olefins may be produced from waste plastics, and syngas containing hydrogen may be obtained therefrom.

The method and system for producing syngas containing hydrogen from waste plastics according to the present disclosure may be used in production of eco-friendly syngas containing hydrogen using waste plastics as a feedstock.

Although the embodiments of the present disclosure have been described, the embodiments are not limited to these embodiments, and those skilled in the art will appreciate that various modifications and alterations may be made without departing from the concept and scope of the claims described below. Furthermore, the embodiments may be combined to form additional embodiments.

### LIST OF NUMERALS IN THE FIGURES

2 waste plastics
10 pyrolysis reactor
12 pyrolysis gas
20 hot filter
22 condenser
24 waste plastic pyrolysis oil
26 water
28 demulsifier
30 dehydrator
32 coalescer
34 dehydrated first mixed solution
36 recycle gas
37 H₂
38 Sulfur source
40 hydrotreating reactor
41 hydrotreated second mixed solution
42-1 to 42-4 gas liquid separators
44 off-gas
46 refined oil
50 gasification
52 syngas

What is claimed is:

1. A method for producing syngas containing hydrogen from waste plastics, the method comprising:
S1 introducing waste plastics into a pyrolysis reactor and pyrolyzing the waste plastics to produce pyrolysis gas;
S2 producing waste plastic pyrolysis oil by introducing the pyrolysis gas into a hot filter filled with a neutralizing agent;
S3 applying a voltage to a first mixed solution obtained by mixing the waste plastic pyrolysis oil, washing water, and a demulsifier to dehydrate the first mixed solution;
S4 hydrotreating a second mixed solution obtained by mixing the first mixed solution dehydrated in the operation S3 and a sulfur source to produce refined oil from which impurities are removed; and
S5 gasifying the refined oil from which impurities are removed.

2. The method of claim 1, wherein in the operation S3, the waste plastic pyrolysis oil is mixed in a greater volume than the washing water.

3. The method of claim 2, wherein in the operation S3, the waste plastic pyrolysis oil and the washing water are mixed in the first mixed solution at a volume ratio of 1:0.001 to 1:0.5.

4. The method of claim 1, wherein in the operation S3, the waste plastic pyrolysis oil and the demulsifier are mixed in the first mixed solution at a volume ratio of 1:0.000001 to 1:0.001.

5. The method of claim 1, wherein the voltage is applied as an alternating current or a combination of an alternating current and a direct current.

6. The method of claim 1, wherein the voltage is applied through at least one pair of vertical electrodes.

7. The method of claim 1, further comprising, after the application of the voltage in the operation S3, removing a rag layer from the first mixed solution.

8. The method of claim 1, wherein the operation S3 is performed under a temperature condition of 20° C. to 300° C.

9. The method of claim 1, wherein a ratio of a content of moisture in the waste plastic pyrolysis oil to a content of moisture in the first mixed solution dehydrated in the operation S3 is 1:0.0001 to 1:0.9.

10. The method of claim 1, wherein in the operation S3, the dehydrated first mixed solution is additionally dehydrated by condensation of moisture.

11. The method of claim 1, wherein a weight ratio of nitrogen to chlorine in the second mixed solution is 1:1 to 1:10.

12. The method of claim 1, wherein the sulfur source includes sulfur-containing oil.

13. The method of claim 12, wherein the sulfur-containing oil is included in an amount of less than 0.5 parts by weight with respect to 100 parts by weight of the first mixed solution dehydrated in the operation S3.

14. The method of claim 1, wherein the sulfur source includes one or two or more sulfur-containing organic compounds selected from a disulfide-based compound, a sulfide-based compound, a sulfonate-based compound, and a sulfate-based compound.

15. The method of claim 1, wherein the hydrotreating is performed in the presence of a molybdenum-based hydrotreating catalyst.

16. The method of claim 15, wherein the molybdenum-based hydrotreating catalyst is a catalyst in which a molybdenum-based metal, or a metal including one or two or more selected from nickel, cobalt, and tungsten, and a molybdenum-based metal are supported on a support.

17. The method of claim 1, wherein the hydrotreating is performed under a pressure condition of 50 bar to 150 bar.

18. The method of claim 1, further comprising, after the operation S4, subjecting a stream including the refined oil from which impurities are removed to gas-liquid separation and then washing the gas-liquid separated stream with water.

19. The method of claim 1, wherein in the operation S5, a refined fraction separated by distilling the refined oil from which impurities are removed is gasified.

20. The method of claim 1, wherein in the operation S5, mixed oil obtained by mixing the refined oil from which impurities are removed and petroleum hydrocarbons is gasified.
